(19) United States
(12) Patent Application Publication
(10) Pub. No.: US 2026/0170289 A1
(43) Pub. Date: Jun. 18, 2026

(54) LARGE LANGUAGE MODEL ("LLM") ASSISTED-CURATION HALLUCINATION-FREE, CONTENT GENERATION SYSTEM

(71) Applicant: Bank of America Corporation, Charlotte, NC (US)

(72) Inventors: John C. O'Keefe, Charlotte, NC (US); Thomas Ellis, Charlotte, NC (US); Hari Gopalkrishnan, Plainsboro, NJ (US); Priyank Shah, Plano, TX (US); Chris Welles, Charlotte, NC (US); Sushil Golani, Waxhaw, NC (US); Tara Daniels, Ponte Vedra Beach, FL (US); Christine Peli, Levittown, PA (US); Claire M. Keith, Fort Mill, SC (US); Jennifer L. Mayo, Doylestown, PA (US); Richard G. Hille, Bordentown, NJ (US)

(21) Appl. No.: 18/978,124

(22) Filed: Dec. 12, 2024

(51) Int. Cl. G06N 3/006; G06F 40/40; G06N 3/0475

(52) U.S. Cl. CPC G06N 3/006; G06F 40/40; G06N 3/0475

(57) ABSTRACT

An LLM assisted-curation, hallucination-free, content generation system is provided. The system may include a user-facing system and a content management system. The user-facing system may receive and respond to questions via a chatbot user interface linked to a production chatbot system. Questions corresponding to responses in need of improvement are electronically transmitted to an LLM within the content management system. The LLM communicates with an information repository to retrieve data relating to the responses in need of improvement. The LLM, constrained by the retrieved data, generates improved answers to the questions. The improved answers are displayed to a content editor via a content management user interface. Upon receipt of approval by the content editor, the improved answers are electronically transmitted to the production chatbot system with which to respond to users.

### FIELD OF TECHNOLOGY

Aspects of the disclosure relate to content generation.

### BACKGROUND OF THE DISCLOSURE

Chatbots are software applications or web interfaces that facilitate communication between entities and users. Chatbots are designed to mimic, in various embodiments, human operators. The users present questions or queries to the entity via the chatbot, and the entity responds to the user via the chatbot. Chatbots typically include a plurality of scripted questions and answers. When the user communicates with the chatbot, the chatbot responds to the user by selecting a scripted answer and presenting the selected answer to the user.

Entities and their systems are continuously evolving, and questions that users present to chatbots are evolving as well. Therefore, certain questions, when presented by a user, may not have a corresponding answer stored in the chatbot. As such, the chatbot may be unable to respond to the questions in a way that satisfies the user.

As such, it would be desirable to create a system to continually or periodically auto-update chatbots to adapt to changing environments. It would be further desirable for such a system to involve a large language model (“LLM”). It would be further desirable for the LLM to provide assisted curation. It would be further desirable to harness the assisted curation abilities of the LLM to generate hallucination-free content. It would be yet further desirable to push the hallucination-free updated content to update a chatbot.

### SUMMARY OF THE DISCLOSURE

Systems, apparatus and methods for generating hallucination-free content for chatbots at an LLM assisted-curation system are provided.

Entities maintain environments and computer systems within the environments. An entity may maintain an existing computer system within a production environment. The production environment may include a chatbot.

The chatbot may communicate with users. The chatbot may receive questions from the users. The chatbot may respond to the questions with one or more answers. The chatbots may also maintain memory. The memory may questions received from users. The memory may also store responses that were presented to displayed to users.

It should be noted that questions may correspond to question intents. As such, the questions may be mapped within the chatbot to one or more question intents. Question intents may be a simple objective the question. An entity may have a listing of a plurality of question intents. Each question received from a user may be semantically mapped, using an entity-specific ontology, to a question intent. Different users may phrase the same difficulty using a different syntax. Therefore, instead of storing and generating the same answer to many different syntactical variations of the same question, which may waste chatbot resources, a chatbot may map a question to a question intent. The chatbot may then select the response that corresponds to the question intent and present the selected response to the user.

The memory may also store statistical indicators relating to the questions and the responses. Statistical indicators may include a frequency of each question communicated to the chatbot. Statistical indicators may also include a frequency of each question intent communicated to the chatbot. Statistical indicators may also include a frequency of each response communicated to a user via the chatbot. Statistical indicators may also include a timestamp of when a question was last received at the chatbot. Statistical indicators may also include a timestamp of when a response was last communicated by the chatbot. Statistical indicators may include length of each question communicated to the chatbot. Statistical indicators may also include length of each response communicated to the user via the chatbot.

The responses stored within the chatbot memory may demand updating. There may be various triggers that indicate that a response demands updating. The triggers may include responses that are shorter than a predetermined length. The triggers may include responses that are identified as out-of-date-i.e., responses that have not been updated in greater than a predetermined time period. The triggers may also include that chatbot identifying responses that are unable to satisfy the user's request.

The triggers may include responses that are identified as insufficient. The insufficiency may be identified by the user in a system within the chatbot system or outside of the chatbot system. Insufficiencies identified within the chatbot system may include a user providing feedback to the chatbot system, following a response received by the chatbot. The feedback communication may be assigned a sentiment value. The sentiment value may be greater than a predetermined sentiment value threshold, indicating that the feedback was positive. The sentiment value may be less than a predetermined sentiment value threshold, indicating that the feedback was negative. For example, the chatbot may provide a response and the user may provide the following feedback: That is an incorrect response. Such a feedback communication may be assigned a sentiment value less than the predetermined sentiment value threshold. The feedback communication and whether the sentiment value was greater than or less than the sentiment value threshold may be stored by the chatbot. Feedback communications below the predetermined sentiment value threshold may indicate to the chatbot that the response was an insufficient response.

The insufficiency may also be determined by a user executing one of a plurality of actions upon receiving a response from the chatbot. The plurality of actions may include actions being executed within the chatbot and actions being executed in a system external to the chatbot (and within an environment shared with the chatbot). The plurality of actions may include a user following up with a call to the call center to communicate with a live agent. The plurality of actions may include a user repeating a question to the chatbot. The plurality of actions may include a user rephrasing the question to the chatbot. Rephrasing of a question may be identified by the user communicating a question including a second set of words, and the second set of words may be a different set of words than the first set of words used to ask the initial question, however the first set of words and the second set of words may map to the same question intent.

There may be a listener within the chatbot that communicates with systems external to the chatbot. The listener may receive indications of actions executed in the systems external to the chatbot. The listener may process actions that indicate a level of insufficiency of a chatbot response. The chatbot may store the indication of the level of insufficiency with the chatbot response within the chatbot memory.

The questions that correspond to responses that demand updating (and/or the responses that demand updating) may be fed, together with information retrieved from an information repository into a large language model (“LLM”). The information may include laws, policies, procedures, product details, documents and other suitable information. The LLM, constrained by the retrieved information, may curate the retrieved information to generate a response that corresponds to the question that corresponds to responses that demand updating.

In one example, the responses to the following question: What is a 401K? may be out-of-date. As such, the question What is a 401K? is input into the LLM. The LLM may be compelled to initially communicate with an information repository to locate various documents and information relating to 401 ks. The LLM, constrained by the retrieved documents and information would provide an updated response to the question What is a 401K? The updated response, the corresponding question and the various documents and information relating to a 401 k may be presented to a subject matter expert (“SME”) via a content management graphical user interface. The SME could check and verify the question and the updated response by reviewing the presented documents. Upon checking and verifying the updated response, the SME may be enabled to approve the updated response.

Upon approval, the updated response (and/or the corresponding question) may be passed to the chatbot. The corresponding question may be stored within the chatbot. The chatbot may store the updated response as content within the chatbot memory. As such, within the production environment, when a user presents the question What is a 401 k? to the chatbot, the user may be presented with the updated response that updated with the latest information retrieved from the information repository.

Such a system maintains an updated chatbot while adding an additional level of verification. The additional level of verification may countereffect blind trust of the LLM. The additional level of verification maintains a level of accuracy and removes hallucinations before the response is returned to the chatbot.

Methods may include receiving, at a user-facing system, one or more questions from one or more users at a chatbot user interface. Methods may also include responding, at the user-facing system, to the one or more questions, at the user-facing system, from the one or more users, at the chatbot user interface, by communicating with a production chatbot system involving a natural language processor.

Methods may include monitoring, at the user-facing system, the chatbot user interface and the production chatbot system to identify chatbot system-generated answers below a threshold level of satisfaction. The system-generated answers may be generated in response to, and corresponding to, one or more selected questions from the one or more questions.

Methods may include electronically communicating, at the user-facing system, the one or more selected questions and the chatbot system-generated answers below the threshold level of satisfaction to the LLM.

Methods may include generating, at a content management system, a list of answers below the threshold level of satisfaction. The list of answers may include a predetermined number of answers.

Methods may include prioritizing the list of answers at the content management system. The answers may be prioritized based on answers that are provided to users greater than a threshold of frequency. The answers may also be prioritized based on seasonal modifiers. The seasonal modifiers may determine which answers are highest priority during a predetermined season.

Methods may include searching the information repository at the content management system. The information repository may be in communication with the LLM. The searching may locate one or more documents and/or data elements corresponding to a top answer on the list of answers.

Methods may include combining, at the content management system, the top answer with the one or more documents and/or data elements. Methods may include electronically communicating, at the content management system, the top answer and the one or more documents and/or data elements to the LLM.

Methods may include instantiating, at the LLM, a retrieval augmented generation process. The retrieval augmented generation process may constrain the LLM to generate a suggested improved answer to overwrite the top answer. The suggested improved answer may be based on the one or more documents and/or data elements. Methods may include transmitting, at the LLM, the suggested improved answer to the content management system.

Methods may include displaying, at a content management user interface, the suggested improved answer. Methods may include enabling, at the content management user interface, a content editor to make further edits to the suggested improved answer. Methods may include verifying, at the content management user interface, information within the suggested improved answer. Methods may include approving, at the content management user interface, the suggested improved answer. The approval may be received from the content editor.

Upon approving, methods may include overwriting, at the content management system, the top answer with the suggested improved answer. Upon approving, methods may also include removing, at the content management system, the top answer from the list of answers. Upon approving, methods may also include forwarding, at the content management system, the one or more suggested improved answers to the production chatbot system.

Upon approving, methods may also include assigning each element on the list a numerical location identifier. The numerical location identifier may be identified by a variable. Methods may also include moving each element within the list from a location identified by the numerical location identifier to a location on the list identified by the variable minus one. Methods may also include maintaining a null memory location, identified by the variable, on the list of answers. The null memory location may be available for a new answer that is determined to be rated below the predetermined threshold level of satisfaction. Methods may also include inputting the new answer into the memory location identified by the variable.

Methods may include storing, at the user-facing system, the suggested improved answer, within the chatbot system. Methods may also include responding, at the user-facing system, to one or more questions at the chatbot user interface with the suggested improved answer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure; and

FIG. 4 shows an illustrative flow diagram in accordance with principles of the disclosure.

### DETAILED DESCRIPTION OF THE DISCLOSURE

Systems, apparatus and methods for a large language model (“LLM”) assisted-curation, hallucination-free, content generation system is provided. The system may include a user-facing system and a content management system.

The user-facing system may include a chatbot graphical user interface and a natural language processor. The chatbot graphical user interface may receive user questions. The chatbot graphical user interface may communicate with the natural language processor to identify responses to the user questions. The chatbot graphical user interface may respond to the user questions with the identified responses.

The natural language processor may monitor the identified responses to identify and select responses that rate below a predetermined threshold level of satisfaction. The natural language processor may transmit the selected responses that rate below the predetermined threshold level of satisfaction and corresponding user questions that prompted generation of the selected responses to the content management system.

Responses that rate below the threshold level of satisfaction may correspond to out-of-date responses, responses that lack information to answer the one or more user questions. Responses that rate below the predetermined threshold level of satisfaction may also correspond to responses to which negative feedback was received from a user. Responses that rate below the predetermined threshold level of satisfaction may also correspond to responses to which the user responded with an action. The action may be one or more of the followings: a telephone call to a call center to talk to an agent, a repetition of the question and a rephrasing of the question. Responses that rate below the predetermined threshold level of satisfaction may correspond to answers that have not been updated in a predetermined amount of time. The predetermined amount of time may be three months, six months, one year or any other suitable amount of time. Responses that rate below the predetermined threshold level of satisfaction may correspond to responses that fail to include sufficient data to satisfy the user's question.

The content management system may include an LLM, an information repository and a content management user interface. The LLM may receive each selected response that rates below the predetermined threshold level of satisfaction and corresponding user question that prompted generation of the selected response. The LLM may electronically communicate each selected response that rates below the predetermined threshold level of satisfaction and the corresponding user question to the information repository. The electronic communication may include instructions to retrieve one or more documents and/or data elements corresponding to each selected response and the corresponding user question.

The information repository may combine each selected response and the corresponding user question with the one or more documents and/or data elements. The information repository may electronically communicate each combined response, corresponding user question and the one or more documents and/or data elements to the LLM.

The LLM may receive each combined response, corresponding user question and the one or more documents and/or data elements. In response to receipt of each combined response, corresponding user question and the one or more documents and/or data elements, the LLM may instantiate a retrieval augmented generation process. The retrieval augmented generation process may constrain the LLM to generate one or more suggested improved answers to each selected user question. The suggested improved answers may be based on the one or more documents and/or data elements. The LLM may transmit the one or more suggested improved answers to the content management system.

The content management user interface may display the one or more suggested improved answers. The content management user interface may display one or more selectable options that enable a content editor to construct one or more edits to the one or more suggested improved answers. The content management user interface may display one or more selectable options that enable the content editor to verify information within the one or more suggested improved answers. The content management user interface may display one or more selectable options to approve the one or more suggested improved answers. Upon receipt of a selection of the one or more selectable options to approve the one or more suggested improved answers, the content management user interface may forward the one or more suggested improved answers to the user facing system.

The natural language processor may receive the one or more suggested improved answers. The natural language processor may store the one or more suggested improved answers. The natural language processor may respond to one or more questions via the chatbot user interface with the one or more suggested improved answers.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

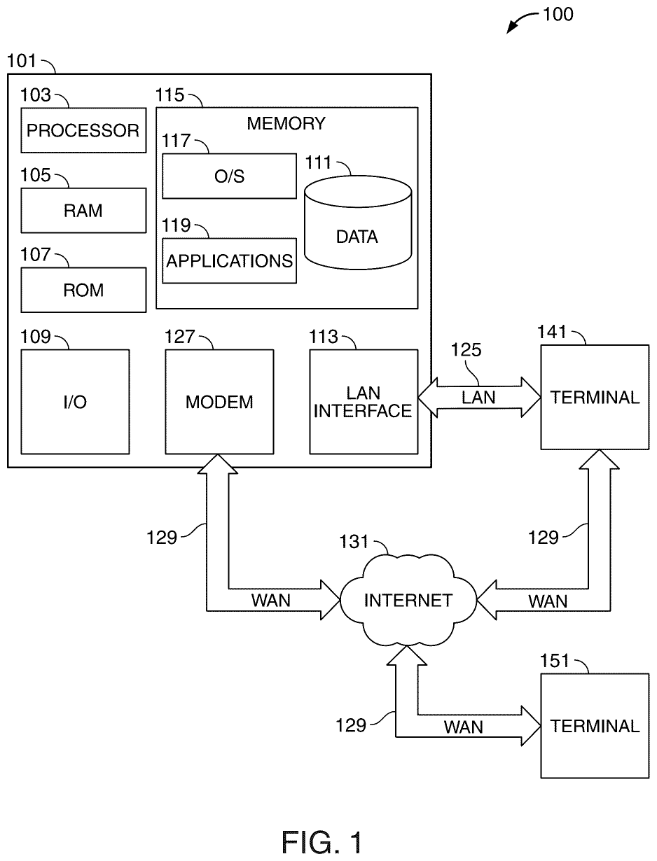

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

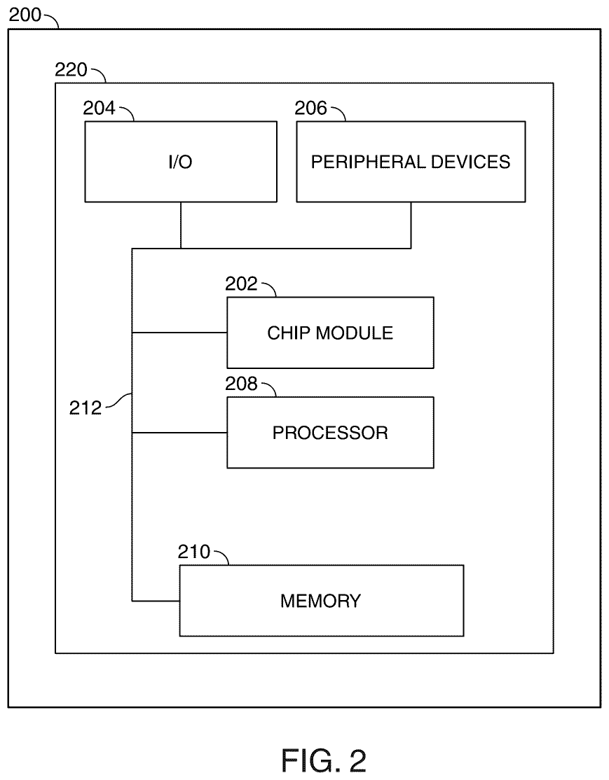

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

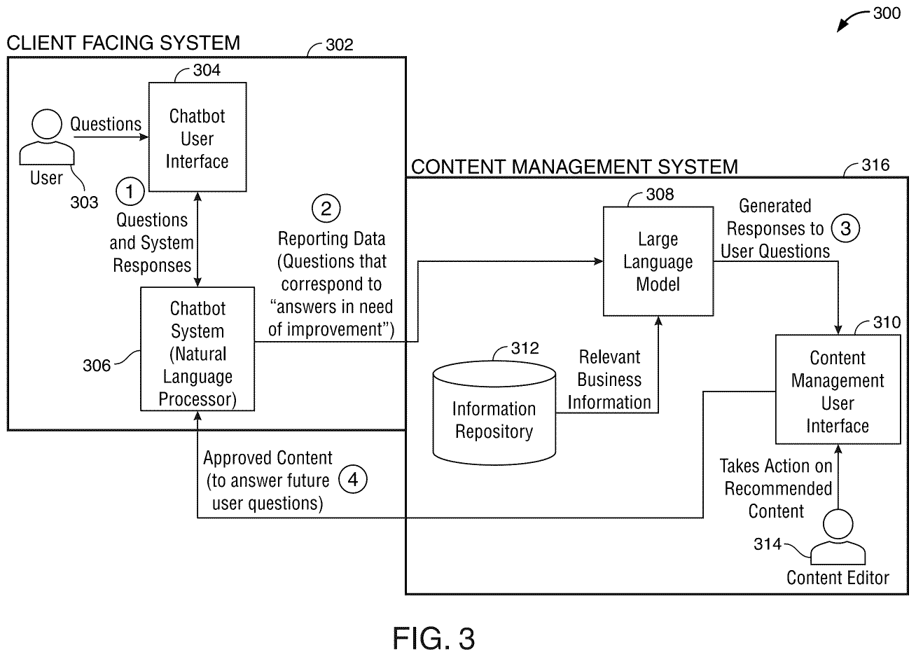

FIG. 3 shows an illustrative diagram 300. Diagram 300 may include client facing system 302 and content management system 316.

User 303 may communicate questions to chatbot user interface 304. Chatbot user interface 304 may be located within client facing system 302. Chatbot user interface 304 may be a graphical user interface, an audio user interface or any other suitable user interface. Chatbot user interface 304 may communicate with a user via text, audio/voice or any other suitable communication mode.

Chatbot user interface 304 may electronically communicate questions received by user 303 to chatbot system (natural language processor) 306. Chatbot system (natural language processor) 306 may respond to questions and provide system responses via chatbot user interface 304.

Chatbot system (natural language processor) 306 may also identify questions that correspond to answers in need of improvement. Chatbot system (natural language processor) 306 may identify such questions from data internal to the chatbot system, data received from a variety of external sources and a combination of the data internal to the chatbot system and the data received from the variety of external sources.

Reporting data, including questions that correspond to answers in need of improvement may be electronically communicated to the content management system 316. It should be noted that client facing system 302 may be an online, real-time, production environment that communicates with users external to the entity and internal to the entity while content management system 316 may be an offline, non-real-time, test environment that communicates with users internal to the entity. Users external to the entity may be prevented from accessing content management system 316. At times, content management system 316 may deploy changes made to answers in an additional test environment before being deployed within the production environment.

Large language model 308, within content management system 316, may receive reporting data including questions that correspond to answers in need of improvement. Upon receipt of reporting data, large language model 308 may communicate the reporting to data information repository 312. Information repository 312 may retrieve relevant business information for each question within the reporting data. Information repository 312 may communicate the relevant business information to large language model 308. Large language model 308, constrained by the relevant business information, may generate a response to the question.

The generated response and the relevant business information may be electronically communicated from large language model 308 to content management user interface 310, within content management system 316. Content management user interface 310 may be a graphical user interface, an audio user interface, a combination user interface or any other suitable user interface. Content management user interface 310 may enable content editor 314 to take one or more actions on the recommended content-i.e., the generated response to the user question. The action may include verifying the content, editing the content, approving the content or any other suitable action. Upon approval of the content from the content editor, the approved content may be electronically communicated to chatbot system 306, within client facing system 302.

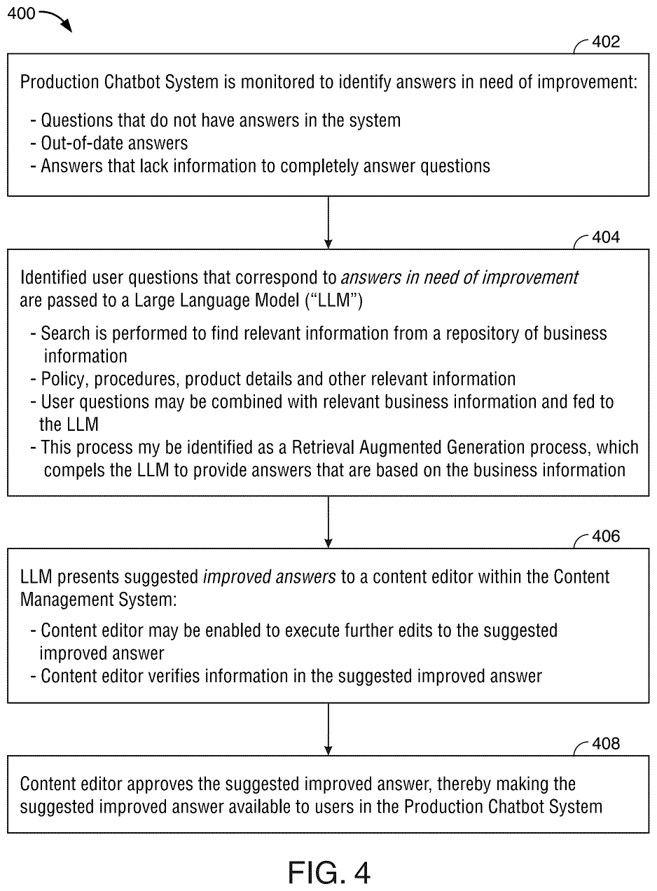

FIG. 4 shows an illustrative flow diagram. Step 402 shows pipeline of answers within a production chatbot that need to be improved. The production chatbot may be monitored by monitoring processor external to the chatbot or by a monitoring module internal to the chatbot for answers in need of improvement.

Answers in need of improvement may include answers that correspond to questions that do not have answers in the system. Answers in need of improvement may include out-of-date answers. Answers in need of improvement may include answers that lack information to completely answer the user question.

Step 404 shows identified user questions that correspond to answers in need of improvement may be passed to a large language model (“LLM”). A search may be performed to find relevant information from a repository of business information. The repository of business information may include policy, procedures, product details and other relevant information. Upon completion of the search, user questions may be combined with relevant business information and fed to the LLM. This process may be identified as a Retrieval Augmented Generation process. Such a Retrieval Augmented Generation process may compel the LLM to provide answers that are based on the business information.

Step 406 shows the LLM presents suggested improved answers to a content editor within the Content Management System. The content editor may be enabled to execute further edits to the suggested improved answer. The content editor may verify information in the suggested improved answer.

Step 408 shows the content editor approves the suggested improved answer, thereby making the suggested approved answer to users in the Production Chatbot System.

In some embodiments the system may periodically, on a predetermined schedule, retrieve a top predetermined number of answers that are in need of improvement. The top predetermined number of answers may be forty. As a more effective answer is identified to replace an answer, the more effective answer may replace the less effective answer, and the answer may be removed from the answers that are in need of improvement. The system may locate replacement answers based on priority. Priority may be driven based on answers that are provided more frequently, answers that are critical based on the type of question asked (e.g., seasonal modifiers may be assigned higher priority) and any other suitable criteria.

Thus, methods and apparatus for a LARGE LANGUAGE MODEL (“LLM”) ASSISTED CURATION, HALLUCINATION-FREE CONTENT GENERATION SYSTEM are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for generating hallucination-free content for chatbots at a large language model (“LLM”), assisted-curation, system, the method comprising:
at a user-facing system:
receiving one or more questions from one or more users at a chatbot user interface;
responding to the one or more questions from the one or more users at the chatbot user interface by communicating with a production chatbot system involving a natural language processor;
monitoring a chatbot user interface and the production chatbot system to identify chatbot system-generated answers below a threshold level of satisfaction, said system-generated answers being generated in response to one or more selected questions from the one or more questions; and
electronically communicating the one or more selected questions to the LLM;
at a content management system, for each selected question included in the one or more selected questions:
at an information repository:
searching the information repository, said information repository in communication with the LLM, for one or more documents and/or data elements corresponding to each selected question;
combining each selected question with the one or more documents and/or data elements; and
electronically communicating each selected question and the one or more documents and/or data elements to the LLM;
at the LLM:
instantiating a retrieval augmented generation process that constrains the LLM to generate one or more suggested improved answers to each selected question that are based on the one or more documents and/or data elements; and
transmitting the one or more suggested improved answers to a content management user interface;
at the content management user interface:
displaying the one or more suggested improved answers;
enabling a content editor to make further edits to the one or more suggested improved answers;
verifying information within the one or more suggested improved answers;
approving the one or more suggested improved answers; and
upon approving, forwarding the one or more suggested improved answers to the production chatbot system;
at the user-facing system:
storing the one or more suggested improved answers within the production chatbot system; and
responding to one or more questions at the chatbot user interface with the one or more suggested improved answers.

2. The method of claim 1 wherein answers below a threshold level of satisfaction correspond to:
out-of-date answers; and
answers that lack information to answer the one or more questions.

3. The method of claim 1 wherein the information repository comprises business information, policy, procedures and product details.

4. The method of claim 1 wherein answers below a threshold level of satisfaction correspond to answers:
to which negative feedback was received from the one or more users; and
to which the one or more users followed up with an action included in the following group of actions: a follow-up call to a call center to talk to an agent, a repetition of the one or more questions and a rephrasing of the one or more questions.

5. The method of claim 1 wherein answers below a threshold level of satisfaction correspond to answers that fail to have been updated in a predetermined amount of time.

6. The method of claim 5, wherein the predetermined amount of time is one year.

7. The method of claim 1 wherein answers below a threshold level of satisfaction correspond to answers that do not include enough information to satisfy the one or more questions.

8. A method for generating hallucination-free content for chatbots at a large language model (“LLM”) assisted curation system, the method comprising:
at a user-facing system:
receiving one or more questions from one or more users at a chatbot user interface;
responding to the one or more questions from the one or more users at the chatbot user interface by communicating with a production chatbot system involving a natural language processor;
monitoring the chatbot user interface and the production chatbot system to identify chatbot system-generated answers below a predetermined threshold level of satisfaction, said system-generated answers being generated in response to, and corresponding to, one or more selected questions from the one or more questions; and
electronically communicating the one or more selected questions and the chatbot system-generated answers below the predetermined threshold level of satisfaction to the LLM;
at a content management system:
generating a list of answers below the predetermined threshold level of satisfaction, said list of answers comprising a predetermined number of answers;
prioritizing the list of answers based on:
answers that are provided to users greater than a threshold of frequency; and
seasonal modifiers, said seasonal modifiers determining which answers are highest priority during a predetermined season;
searching an information repository, said information repository in communication with the LLM, for one or more documents and/or data elements corresponding to a top answer on the list of answers;
combining the top answer with the one or more documents and/or data elements; and
electronically communicating the top answer and the one or more documents and/or data elements to the LLM;
at the LLM:
instantiating a retrieval augmented generation process that constrains the LLM to generate a suggested improved answer to overwrite the top answer, said suggested improved answer based on the one or more documents and/or data elements; and
transmitting the suggested improved answer to the content management system;
at a content management user interface:
displaying the suggested improved answer;
enabling a content editor to make further edits to the suggested improved answer;
verifying information within the suggested improved answer;
approving the suggested improved answer; and
upon approving:
overwriting the top answer with the suggested improved answer;
removing the top answer from the list of answers;
forwarding the suggested improved answer to the production chatbot system;
at the user-facing system:
storing the suggested improved answer within the production chatbot system; and
responding to one or more questions at the chatbot user interface with the suggested improved answer.

9. The method of claim 8 wherein the information repository comprises business information, policy, procedures and product details.

10. The method of claim 8 further comprising, upon approving:
assigning each element on the list a numerical location identifier, said numerical location identifier being identified by a variable;
moving each element within the list from a location identified by the numerical location identifier to a location on the list identified by the variable minus one;
maintaining a null memory location, identified by the variable, on the list of answers, for a new answer that is determined to be rated below the predetermined threshold level of satisfaction; and
inputting the new answer into the null memory location identified by the variable.

11. A Large Language Model (“LLM”) assisted-curation, hallucination-free, content generation system, the system comprising:
a user facing system, said user facing system comprising:
a chatbot graphical user interface operable to:
receive user questions;
communicate with a natural language processor to identify responses to the user questions; and
respond to the user questions with the identified responses;
the natural language processor operable to:
monitor the identified responses to identify and select responses that rate below a predetermined threshold level of satisfaction; and
transmit the selected responses that rate below the predetermined threshold level of satisfaction and corresponding user questions that prompted generation of the selected responses to a content management system;
a content management system, said content management system comprising:
a large language model (“LLM”) operable to:
receive each selected response that rates below the predetermined threshold level of satisfaction and corresponding user question that prompted generation of the selected response; and
electronically communicate each selected response that rates below the predetermined threshold level of satisfaction and the corresponding user question to an information repository, said electronic communication comprising instructions to retrieve one or more documents and/or data elements corresponding to each selected response and the corresponding user question;
the information repository operable to:
combine each selected response and the corresponding user question with the one or more documents and/or data elements;
electronically communicate each combined response, corresponding user question and the one or more documents and/or data elements to the LLM;
the LLM is further operable to:
receive each combined response, corresponding user question and the one or more documents and/or data elements;
in response to receipt of each combined response, corresponding user question and the one or more documents and/or data elements, instantiate a retrieval augmented generation process that constrains the LLM to generate one or more suggested improved answers, to each selected user question, which are based on the one or more documents and/or data elements; and
transmit the one or more suggested improved answers to a content management user interface;
the content management user interface operable to:
display the one or more suggested improved answers;
display one or more selectable options that enable a content editor to construct one or more edits to the one or more suggested improved answers;
display one or more selectable options that enable the content editor to verify information within the one or more suggested improved answers; and
display one or more selectable options to approve the one or more suggested improved answers; and
upon receipt of a selection of the one or more selectable options to approve the one or more suggested improved answers, forward the one or more suggested improved answers to the user facing system;
the natural language processor further operable to:
receive the one or more suggested improved answers;
store the one or more suggested improved answers; and
respond to one or more questions via the chatbot graphical user interface with the one or more suggested improved answers.

12. The LLM assisted-curation, hallucination-free, content generation system of claim 11, wherein answers that rate below the predetermined threshold level of satisfaction correspond to:
out-of-date responses; and
responses that lack information to answer the user questions.

13. The LLM assisted-curation, hallucination-free, content generation system of claim 11, wherein the information repository comprises business information, policy, procedures and product details.

14. The LLM assisted-curation, hallucination-free, content generation system of claim 11, wherein responses that rate below the predetermined threshold level of satisfaction correspond to:
responses to which negative feedback was received from a user; and
responses to which the user responded with an action included in the following group of actions: a telephone call to a call center to talk to an agent, a repetition of the question and a rephrasing of the question.

15. The LLM assisted-curation, hallucination-free, content generation system of claim 11, wherein responses that rate below the predetermined threshold level of satisfaction correspond to answers that have not been updated in a predetermined amount of time.

16. The LLM assisted-curation, hallucination-free, content generation system of claim 15, wherein the predetermined amount of time is one year.

17. The LLM assisted-curation, hallucination-free, content generation system of claim 11, wherein responses that rate below the predetermined threshold level of satisfaction correspond to responses that fail to include sufficient data to satisfy the user questions.
